(19) United States
(12) Patent Application Publication
(10) Pub. No.: US 2014/0190883 A1
(43) Pub. Date: Jul. 10, 2014

(54) CONSTRUCTION SITE WATER FILTRATION SYSTEM

(71) Applicant: HANDA CONSTRUCTION, INC., Vista, CA (US)

(72) Inventor: Jeffrey Handa, Vista, CA (US)

(73) Assignee: HANDA CONSTRUCTION, INC., Vista, CA (US)

(21) Appl. No.: 13/734,711

(22) Filed: Jan. 4, 2013

(51) Int. Cl. B01D 29/56

(52) U.S. Cl. CPC B01D 29/56
USPC 210/337

(57) ABSTRACT

A water filtration assembly is provided including a bottom fluid container having a floor portion, an open top portion, and a sidewall. The sidewall defines an inwardly extending filter assembly support surface. At least one fluid container segment is provided for vertically stacking and engagement to the bottom container and other container segments. The fluid container segments also define an inwardly extending fluid assembly support surface. A first filter assembly for removing contaminates is disposable within the bottom fluid container, supported by the bottom container filter assembly support surface. At least one second filter assembly for removing contaminates is disposable within the container segment(s), supported on the container segment filter assembly support surface.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to water filtration products, and more particularly to a water filtration assembly having a particular application to construction site requirements.

Water filtration products are used for a variety of difference reasons purpose. For household use, water filtration products are commonly implemented as either whole house water filtration systems, or as point of use filtration products, such as shower filters, drinking water filters, or refrigerator filters. Whole house and point of use water systems operate to provide further filtering for portable water.

Municipal water filter systems includes discharge systems which receive contaminated water and remove contaminates before the water is discharged, or recycled, typically as non-portal water. Other municipal water systems purify water received from a source to produce potable water which then may be delivered to homes, or businesses for drinking, and other uses. As will be apparent, the filtration requirements associated with different water systems depends upon the particular use, and upon applicable regulatory requirements.

Construction sites utilize water for a variety of reasons, e.g. cleaning tools, paint brushes, etc. In some cases, the water used for such requirements is either maintained in buckets or other containers. Once the construction worker is done cleaning, the water in those containers needs to be properly disposed of. However, in practice such water may simply be dumped onto the ground, into a hole in the ground, or behind a shrub. Such practices may be illegal, potentially harmful to landscaping and ground soil, and may create safety concerns.

Accordingly, there is a necessity for a construction site water filtration assembly which provides a practical alternative to the common practice of dumping water including paints, gypsum, oils, and other contaminates into random areas about the construction site, which may cause environmental harm, property damage and safety concerns.

Moreover, there is a need to provide a construction site water filtration assembly which functions to capture contaminates from water used on construction site in a simple, efficient manner that requires no plumbing, removes a variety of contaminates for convenient disposal. It is also desirable that the water filtration assembly to be inexpensive, use readily available components, and be simple to assemble.

These and other objects and advantages are addressed by the present invention which is described below in connection with accompanying drawings.

### BRIEF SUMMARY

A water filtration assembly is provided including a bottom fluid container having a floor portion, an open top portion, and a sidewall. The sidewall defines an inwardly extending filter assembly support surface. At least one fluid container segment is provided for vertically stacking engagement to the bottom container and other container segments. The fluid container segments also define an inwardly extending fluid assembly support surface. A first filter assembly for removing contaminates is disposable within the bottom fluid container, supported by the bottom container filter assembly support surface. At least one second filter assembly for removing contaminates is disposable within the container segment(s), supported on the container segment filter assembly support surface.

The bottom container may include a rim extending about the open top portion of the bottom container. At least one of the container segments may define a pair of handles, formed on the outside surface of the container segment, such that upon stacking the container segment upon the bottom container, or on other container segments, the handles abut against the rim to support the segment and to provide vertical spacing between the filter assemblies. The container segments may similarly define a rim about the container segment upper portion.

The handles also facilitate assembly and disassembly of the filtration product. The handles of the succeeding container segments may also abut against the rim of the proceeding container segment to support the container segment to support the container segments and provide vertical spacing between the respective container segment filter assemblies.

The filter assembly support surface may be implemented as an inwardly extending circumferential rim formed on the inner surface of the bottom container and/or container segments.

Alternatively, the filter assembly support surface may be implemented as one or more inwardly extending protrusions formed on the inner surface of the bottom container, and/or container segments.

The filter assemblies may be formed to include a filter membrane, which may be formed of paper or other fiberous material.

The filter assembly may also/alternatively include filtration media, such as activated carbon and/or mixture of copper and/or zinc granules. The filter assembly may function to filter a wide variety of contaminates, depending upon the construction of the filter assembly.

In the presently preferred embodiment the bottom container is formed as a cylindrical trash can and the container segments are formed as truncated cylindrical trash cans, having the trash can lower portion cut off.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front perspective view of an exemplary water filtration assembly in accordance with the present invention;

FIG. 2 is an exploded view of the water filtration assembly shown at FIG. 1;

FIG. 3 is an exploded view of a fluid container segment and an exemplary filter assembly;

FIG. 4 is a cross section view of one implementation of the water filtration assembly;

FIG. 5 is a cross sectional view of alternative embodiment of the water filtration assembly; and

FIG. 6 is a cross sectional view of another alternative embodiment of the water filtration assembly.

### DETAILED DESCRIPTION

The above description is given by way of example, and not limitation. Given the above disclosure, one skilled in the art could devise variations that are within the scope and spirit of the invention disclosed herein, including various ways of constructing and stacking the container segments and filter assemblies. Further, the various features of the embodiments disclosed herein can be used alone, or in varying combinations with each other and are not intended to be limited to the specific combination described herein. Thus, the scope of the claims is not to be limited by the illustrated embodiments.

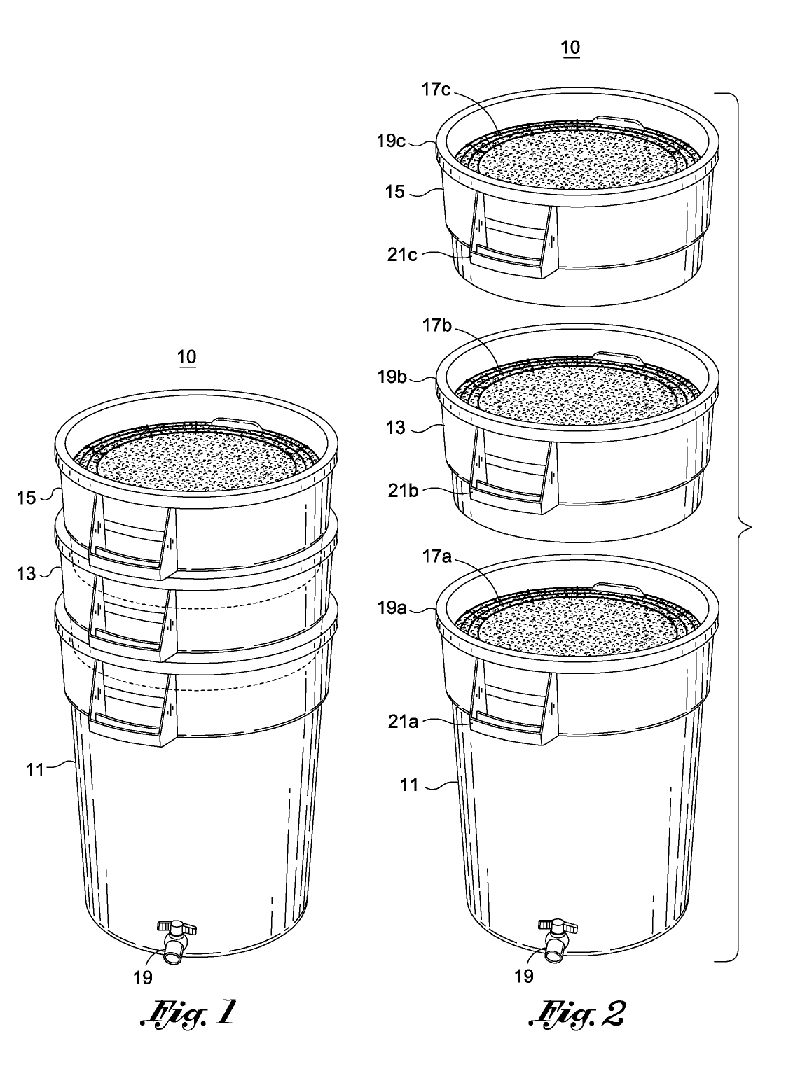

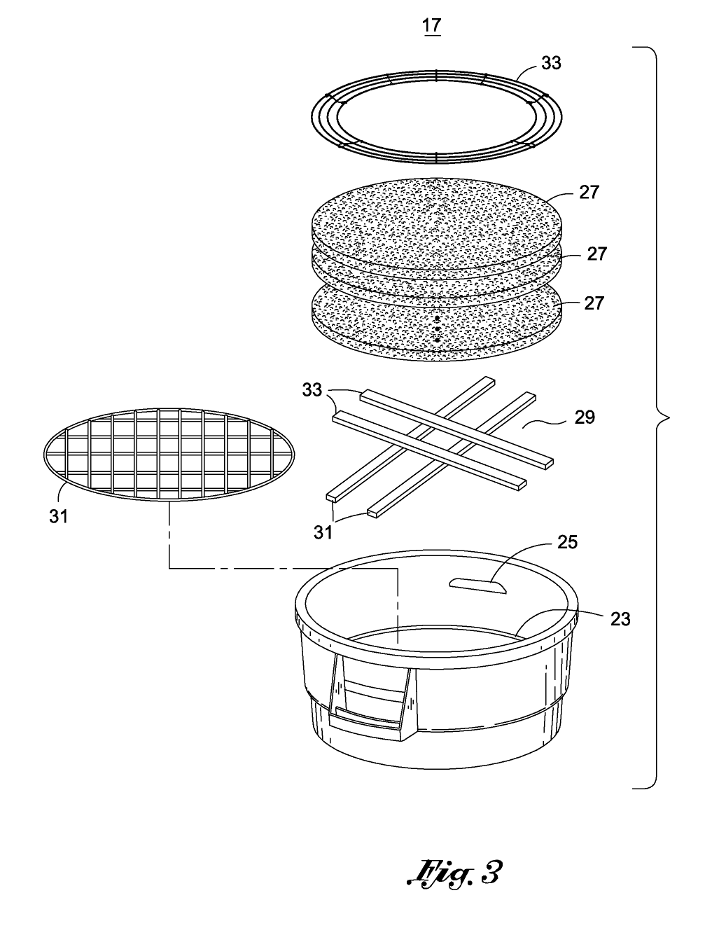

Referring to FIGS. 1 and 2, one embodiment of the present invention is illustrated. As shown therein, water filtration assembly 10 includes bottom fluid container 11 and fluid container segments 13, 15. The bottom fluid container 11, as well as container segments 13 and 15, each may include a filter assembly 17a, 17b, and 17c respectively. In operation, the contaminated fluid may be poured into the open top portion of container segment 15 and travel through the water filter assemblies 17c, 17b, and 17a. Contaminates are captured by the filter assemblies and the filtered fluid may accumulate in bottom fluid container 11, and may be discharged through valve 19. When the filter assemblies 17a, 17b, and 17c become dirty, they can be readily removed from the filter assembly and cleaned, or replaced with new filter assemblies.

As it will be apparent from FIGS. 1 and 2, the water filtration assembly 10 may be formed of conventional cylindrical trash cans. Bottom fluid container 11 may be formed as a conventional trash can which may or may not be modified to include valve 19. Container segments 13 and 15 may be formed by the same type of trash can, truncated to remove the lower portion of the trash cans. The number of such container segments used is a matter of design choice depending upon the filtration requirements.

In the presently preferred embodiment, the bottom container and the container segments are each formed to define an upper rim 19a, 19b, 19c and handles 21a, 21b, 21c. As a container segment is stacked upon the bottom container, or other container segments, the handle engages the rim of the preceding container/segment to secure the segment in place and provide for vertical spacing of the filter assemblies 17a, 17b, and 17c.

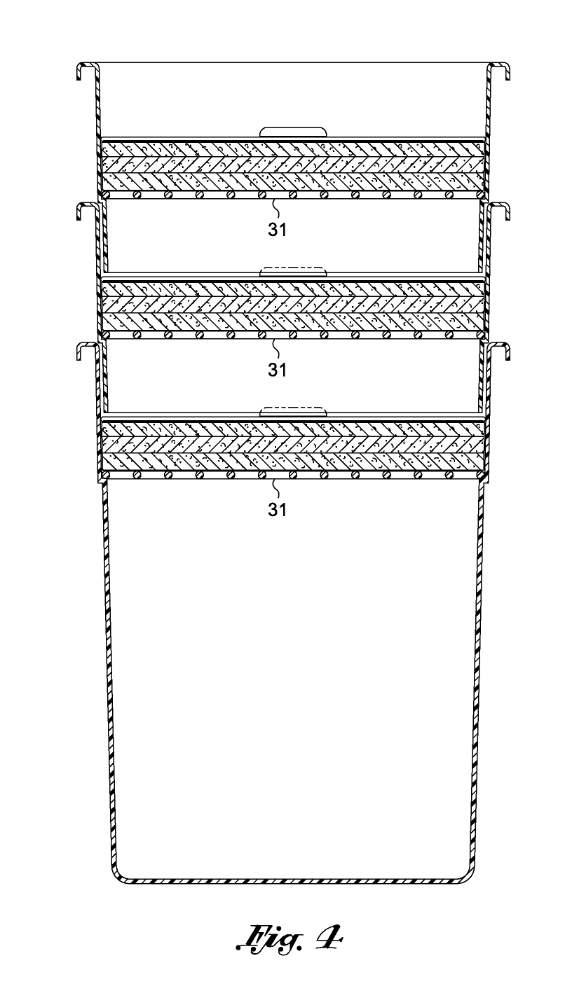

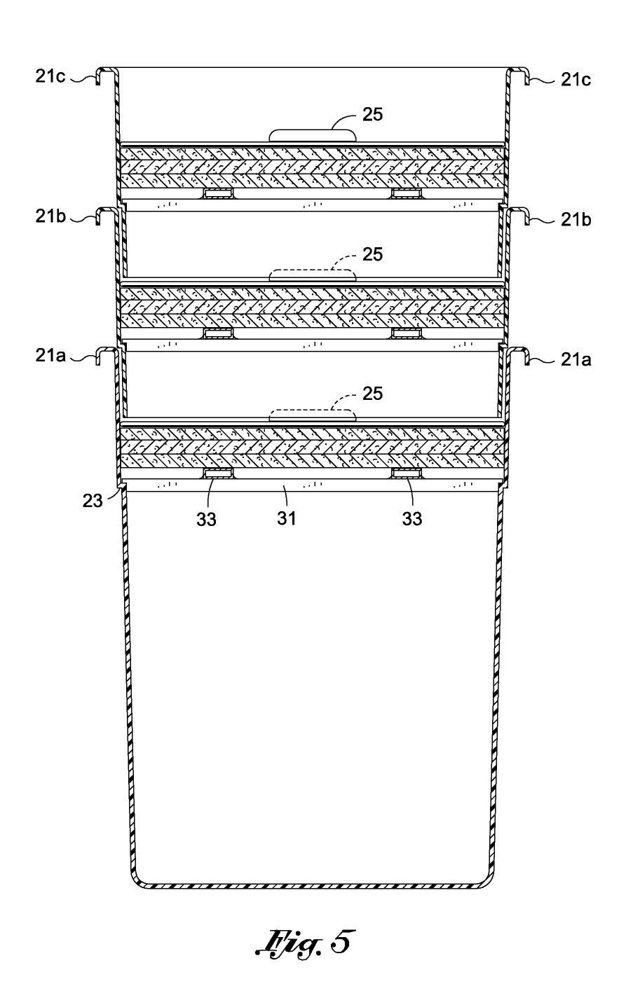

An exemplary arrangement of a filter assembly is illustrated at FIG. 3. As shown therein, and as further illustrated at FIGS. 4-6, the interior of the bottom fluid container 11 and segments 13, 15 may be formed to define an inwardly extending filter assembly support surface 23, shown as a circumferential rim, which supports the filter assembly 17. Alternatively/additionally, the bottom fluid container 11 and/or container segments 13, 15 may define one or more inwardly extending protrusions 25 that function to support the filter assembly 17. As it will be apparent to one of ordinary skill, the particular construction of the filter assembly support surface will depend on the particular construction of the container, and the container segments. In each case, an inwardly extending surface is provided on the container and/or container segments, either by the initial design of the container or by other means of adding to the container, to support the filter assembly.

Moreover, shown at FIGS. 3-6, the particular construction of the filtration assembly may vary. In its simplest form, the filter assembly 17 may be formed to include single membrane 27 supported by filter assembly support surface 23. In other embodiments, the filter assembly 17 may include a plurality of membranes 27 supported by an underlining lattice 29, or grill 31, which in turn are supported by the filter assembly support surface. Further, a retaining ring 33 may be provided above the membrane(s) to provide stability and integrity to the filter assembly 17.

As it will be apparent to one of ordinary skill in the art, the grill 31 may be formed in a manner similar to a barbeque grill, sized to be received within the container and supported by the container segment.

Lattice 29 can be formed of two pairs of overlapping slats 31, 33, with the lower pair of slats supported by the filter assembly retaining surface. However, other equivalent support surfaces may be used to support the membrane(s), as well be readily recognized by those of ordinary skill in the field.

FIG. 4 illustrates an implementation wherein the membrane support surface is implemented as a grill 31.

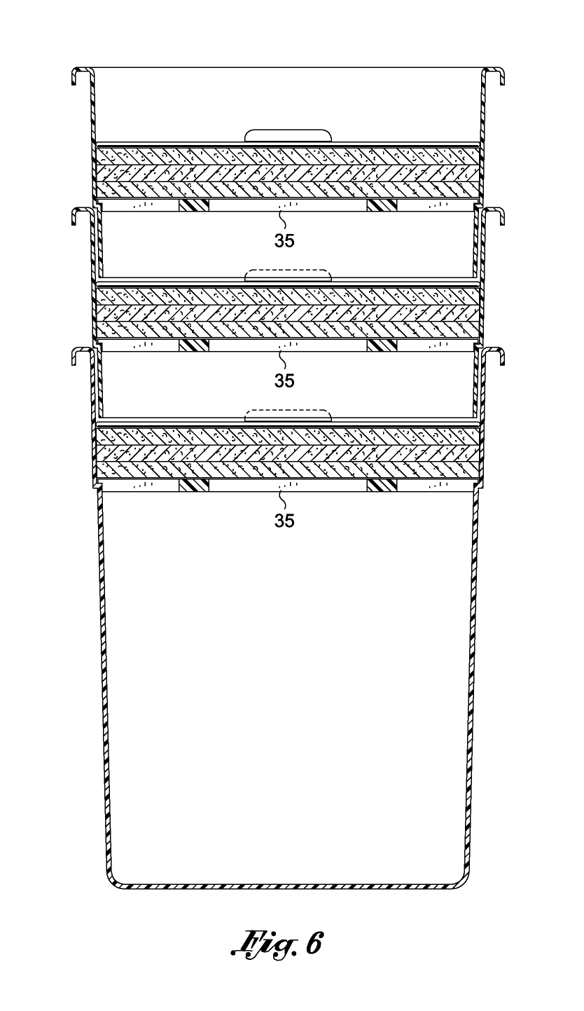

FIG. 5 illustrates an embodiment wherein the membrane support surface is implemented as a pair of overlapping slats, 31, 33.

FIG. 6 illustrates an implementation wherein the lattice 29 is formed to define a coplanar arrangement of crossing slats 35.

In one implementation the filter membrane 27 may be formed of paper or other fiberous material. In another implementation, the filter membrane 27 may be formed to include filter media, such as activated charcoal or a mixture of copper and/or zinc granules. Such mixtures are commonly sold and used in relation to domestic point of use water filter assemblies, such as shower filters. One such mixture is marketed by KDF Fluid Treatment Inc., under the designations KDF®-55 and KDF®-85. Such filtration medias are generally recognized to be effective to filtering a variety of undesirable materials, such as chlorine, chloramine, iron, bacteria, allege, fungus, hydrogen sulfide, arsenic, cryptosporidium, fluoride, lead, mercury, nitrate, cadmium, and other heavy metals.

As it will be apparent to one of ordinary skill, the selection of the membrane and any filter media will vary in accordance with the particular application of the water filter assembly for construction site applications. A paper filter membrane may be adequate to remove paints, oils, plaster, gypsum, and other common construction materials. However, the present invention allows for much greater filtration, as be desired or required by local laws.

What is claimed is:

1. A water filtration assembly comprising:
a bottom fluid container having a floor portion, an open top portion and a sidewall;
the bottom container sidewall defining an inwardly extending filter assembly support surface disposed intermediate the bottom container floor portion and the bottom container open top portion;
at least one fluid container segment having an open bottom portion, an open top portion and a sidewall formed for vertically stackable engagement to the bottom container and other container segments;
the fluid container segment(s) further defining an inwardly extending filter assembly support surface disposed intermediate the container segment open bottom portion and the container segment open top portion;
a first filter assembly for removing contaminates from a fluid, the first filter assembly being disposable within the bottom fluid container, supported by the bottom container filter assembly support surface; and
at least one second filter assembly for removing contaminates from a fluid, the second filter assembly being disposable within the at least one container segment, supported on the container segment filter assembly support surface.

2. The water filter assembly as recited in claim 1 wherein the bottom container further includes a rim extending about the open top portion of the bottom container.

3. The water filter assembly as recited in claim 2 wherein the at least one container segment defines a pair of handles formed on an outer surface of the container segment, such that upon stacking the container segment upon the bottom container the handles abut against the bottom container rim to support the at least one container segment and to provide vertical spacing between first filter assembly and the second filter assembly.

4. The water filtration assembly as recited in claim 3 further comprising a plurality of stackable fluid containers segments and a corresponding plurality of second filter assemblies, each container segment including a container segment filter assembly support surface supporting an associated second filter assembly.

5. The water filter assembly as recited in claim 4 wherein each of the container segments defines a rim about the container segment open top portion and a pair of handles formed on an outer surface of the container segments, such that upon stacking the container segments upon each other the handles abut against the rim of an adjacent container segment to support the container segments and to provide vertical spacing between the respective container segment second filter assemblies.

6. The water filter assembly as recited in claim 3 wherein the bottom container filter assembly support surface comprises an inwardly extending circumferential rim formed on an inner surface of the bottom container.

7. The water filter assembly as recited in claim 6 wherein each container segment filter assembly support surface comprises inwardly extending circumferential rim formed on an inner surface of each fluid container segment.

8. The water filter assembly as recited in claim 3 wherein the bottom container filter assembly support surface comprises at least one inwardly extending protrusion formed on an inner surface of the bottom container.

9. The water filter assembly as recited in claim 8 wherein the container segment filter assembly support surface comprises at least one inwardly extending protrusion formed on an inner surface of each container segment.

10. The water filter assembly as recited in claim 1 wherein the first and second filter assemblies are commonly formed.

11. The water filter assembly as recited in claim 1 wherein the first filter assembly includes a filter membrane.

12. The water filter assembly as recited in claim 4 wherein the first filter assembly further includes a filter membrane support surface, supported by the bottom container filter assembly support surface and supporting the filter membrane.

13. The water filter assembly as recited in claim 11 wherein the second filter assembly includes a filter membrane.

14. The water filter assembly as recited in claim 12 wherein the second filter assembly further includes a filter membrane support surface, supported by the container segment filter assembly support surface and supporting the filter membrane.

15. The water filter assembly as recited in claim 5 wherein the bottom container is a cylindrical trash can.

16. The water filter assembly as recited in claim 15 wherein each container segment is a truncated cylindrical trash can.

17. The water filter assembly as recited in claim 11 wherein the container filter membrane is formed as a paper filter.

18. The water filter assembly as recited in claim 5 wherein at least one of the first and second filter assemblies includes a filtration media.

19. The water filter assembly as recited in claim 18 wherein the filtration media is selected from the group of:
activated carbon; and
a mixture of cooper and/or zinc granules.

20. The water filter assembly as recited in claim 19 wherein the filtration media is operative to filter chlorine, chloramine, iron, bacteria, algae, fungus, hydrogen sulfide, and heavy metals.

21. The water filter assembly as recited in claim 20 wherein the contaminates include arsenic, chlorine, chloramines, cryptosporidium, fluoride, lead, mercury, nitrate, cadmium, and bacteria.
